(19) United States
(12) Patent Application Publication
(10) Pub. No.: US 2002/0191602 A1
(43) Pub. Date: Dec. 19, 2002

(54) Address mapping and identification

(76) Inventors: Sherrie L. Woodring, Fairfax, VA (US); Peter Freeland, Springfield, VA (US)

Correspondence Address: BAKER & HOSTETLER LLP, Washington Square, Suite 1100, 1050 Connecticut Avenue, N.W., WASHINGTON, DC, 20036, US

(21) Appl. No.: 10/026,838

(22) Filed: Dec. 27, 2001

Related U.S. Application Data
(60) Provisional application No. 60/297,438, filed on Jun. 13, 2001.

(51) Int. Cl. H04L 12/28

(52) U.S. Cl. 370/389; 370/254

(57) ABSTRACT

Methods for detecting assignment changes as well as address changes in address identifiers (particularly fibre channel—FC-2-address identifiers such as D_ID, S_ID) are disclosed. When such changes are detected, and a probe is in place monitoring at least a portion of a system (i.e., at least one port associated therewith), the detection of a change in address or port assignment triggers a command to map the change to ensure the user defined port name is always correct. The present invention is further directed to methods for monitoring a storage area network, in particular, at least one port associated therewith using user defined port names as a field in any data reported by the monitoring system. The invention is yet further directed to probes and monitoring systems that are capable of generating data that employ statistics or data referring to user-defined port names at least for purposes of archiving and/or viewing such data or statistics.

### PRIORITY

This application claims priority to the provisional U.S. patent application entitled, Address Mapping and Indentification, filed Jun. 13, 2001, having a serial No. 60/297,438, the disclosure of which is hereby incorporated by reference.

### FIELD OF THE INVENTION

The present invention relates generally to mapping fibre channel frames in order to accomplish monitoring of information being sent and/or received in a device and more particularly, to address mapping in connections when monitoring bidirectional datastreams in a Fibre Channel environment.

### BACKGROUND OF THE INVENTION

When displaying service level statistics (e.g. MB/Sec, SCSI IO/Sec) gathered by a probe monitoring a storage area network (SAN), the type of information provided to the end user can often be cryptic at best and as such, difficult to interpret. That is, while a probe is, in fact, connected to a certain port, the data transported on that port is attributed to multiple devices (e.g., server, tape unit, RAID), each addressed by a unique fibre channel identifier (i.e., FC_ID). These identifiers are assigned during an initialization sequence between a device and a fibre channel switch, director, or router. The FC_ID is a 24-bit cryptic address that is difficult for a user to associate with a specific device in the Data Center. In addition, one of the consequences of letting the topology assign addresses is that any given port may receive a different address from one initialization to the next.

It would be highly desirable if there were some method whereby a user could view statistics or other data monitored by a probe by the user-defined port name verses the fibre channel address identifier so that at any point in time, a report would be meaningful to an end user seeking to interpret the same. Further, it would be highly desirable to track changes in the fibre channel identifier to the original user-defined port name. Such a methodology has not been proposed in the past as users are required to manually map or assign the fibre channel identifier to the assigned user-defined port name at some subsequent time in order to provide understanding thereto, whereas it would have been much better had the data been generated in a meaningful format in the first place.

Moreover, users of SANS would be eager to have a method for visually inspecting the type and nature of traffic going through the SAN at any given moment or at any given port location in order to provide the best maintenance and service of the network as possible at any given moment, and throughout the life of the network. In addition, it would be useful for administrators of networks to be able to have a methodology for predicting maximum usage requirements and future needs of each device associated therewith.

To deliver a highly available and performing storage infrastructure for business critical applications, administrators face many challenges when managing Storage Area Networks (SAN):

managing data with fewer IT resources,

managing infrastructure and application changes on a daily basis, delivering system and application performance and

managing flexible deployment of multiple applications across a common infrastructure.

Monitoring the quality of service for a SAN is critical to meeting IT availability and performance goals. It would be desirable to have real-time and trend performance data for critical service-level parameters such as availability, throughput, and utilization. Real-time performance monitoring, with flexible user-defined thresholds, allows administrators to quickly pinpoint issues that could affect overall SAN performance. Historical trending of performance data extends the administrator's capability to audit and validate service-level agreements. Moreover, as mentioned above, there are the problems in the art relating to how such historical and real-time data and statistics could be presented by a probe when such a probe is monitoring traffic attributed to multiple devices addressed by 24-bit cryptic fibre channel identifiers.

### SUMMARY OF THE INVENTION

In accordance with these and other objects, the present invention is directed to methods for detecting assignment changes as well as address changes in address identifiers (particularly fibre channel—FC-2-address identifiers such as D_ID, S_ID). When such changes are detected, and a probe is in place monitoring at least a portion of a system (i.e., at least one port associated therewith), the detection of a change in address or port assignment triggers a command to map the change to ensure the user defined port name is always correct. The invention is yet further directed to probes and monitoring systems that are capable of generating data that employ statistics or data referring to user-defined port names at least for purposes of archiving and/or viewing such data or statistics.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a diagram of a typical storage area network and associated devices.

FIG. 2 is a diagram of a probe system according to the present invention.

FIG. 3 is an architecture employed in one embodiment of a probe system according to the present invention.

FIG. 4 is an architecture employed in another embodiment of a probe system according to the present invention.

FIG. 5 is an implementation of a probe system according to the present invention.

### DETAILED DESCRIPTION OF PREFERRED EMBODIMENTS OF THE INVENTION

According to a preferred embodiment of the present invention, there is provided a system which monitors a port (often a fibre channel port) with a probe, and a method for the purpose of mapping address identifiers to user-defined port names for storing and viewing service level statistics. A “probe” as used herein can be a software or hardware based collection device that monitors frames on a port. When displaying service level statistics, (e.g. in MB/sec) gathered from a probe, users generally prefer viewing statistics that refer to a user-defined port name as opposed to the address identifier (machine level language) used for the frame. For example, in fibre channel (FC-2) the address identifier is an obscure 3-octet identifier (e.g. 3D 09 EF) that is unique within the address domain of the fabric. When a fabric login (i.e. FLOGI) procedure occurs between a fabric switch port and an attached device, such as a server or storage device, the device's FC_ID is assigned by the switch. The fabric switch or director's Fibre Channel Management Framework Integration “MIB” contains the address identifier (FcAddressld) and the user-defined port name (connUnitPortName). This assignment may change between FLOGI sequences. To detect this change and map the new address identifier to the port name in the stored and viewed statistics, the probe system of the present invention monitors traps from the switch or Director, which may indicate topology changes. When a relevant trap is received, the new address identifier is mapped to the port name for storing and viewing purposes. In some embodiments, the new address identifier that is associated with a user-defined port name is generated as at least one field for whatever purposes are desired such as for generating reports or for archiving the data. Further details regarding the mapping are given infra.

According to a preferred embodiment, the present apparatus and methods include mirroring of both the transmit and receive side of a port in a fibre channel switch or director. Mirroring, in a preferred embodiment, involves either 1) splitting preferably about 10% (or from 2-20% in other embodiments) of the optical energy signal or light being directed to a particular port, and sending that partial optical signal to a probe that replicates the nature of the data presently associated with that particular port for use as a monitor to the outside world; 2) external fibre channel patch panel that replicates the data for a given fibre channel port to the probe; or 3) internal replication of data within the switch or director to the probe, referred to as port mirroring. By replicating the signal, it is possible to keep up-to-the-minute statistics on the nature of data then associated with that particular port by viewing the information provided by the probe. The information could be displayed or stored according to any known mechanism including by graphical representations, time based reports, polling of ports, event-based triggers, and the like. The present invention provides many benefits over such prior maintenance systems such as “Veritas” which only provide information in terms of the MB/sec only at the port level.

By employing the present apparatus and/or methods, it is possible to always have current information in terms of the nature of the data then associated with a port (i.e. small I/O, voice data, video, etc.) as well as its relative contribution to the total traffic in the switch, director, or router. It is further possible to have a record of the particular traffic at a particular timeframe so as to permit intelligent decision making by operators as to what devices are contributing to problems experienced by the system.

Fibre channel systems are most often the directors employed in the present marketplace, and as such, the present invention was contemplated with this in mind. However, the invention could, of course, be adapted to other directors and architectures depending on the desired end use without undue experimentation. Fibre Channel topology can be selected depending on system performance requirements or packaging options. Possible fibre channel topologies include point-to-point, crosspoint switched or arbitrated loop. In any of these fibre channel topologies, SCSI storage devices, such as hard disk storage devices and tape devices, can be used to store data that can be retrieved by a software application. Conventionally, fibre channel storage devices have been directly attached to a fibre channel I/O bus on a server.

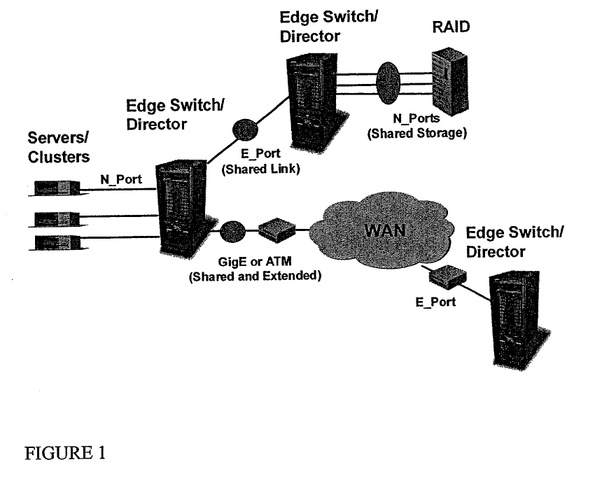

As shown, for example, in FIG. 1, there is shown an exemplary configuration for a storage area network including a WAN. According to the present invention, it is possible to determine which device(s) are contributing to traffic (e.g., MB/sec, SCSI IO/sec). It is further possible to determine what type of traffic in terms of read/write/other, transaction vs. large file I/O. Other aspects of the present invention are capable of ascertaining whether any retransmissions are occurring in the network and which device(s) are responsible for such retransmission and to what extent a particular device is impacting the network or device due to such retransmission on a real-time basis if desired for a particular reason. It is further possible to determine availability, throughput and latency for each device. These and other aspects of the present invention are provided by virtue of the inclusion of a probe system that gathers statistics directly from Fibre Channel links. Statistics are gathered per Fibre Channel link and per-FC_ID (24 bit Fibre Channel ID). The Fibre Channel FC_ID of a device attached to the Fibre Channel fabric is an obscure 24-bit, 3-octet identifier. Thus, a probe system according to the present invention preferably associates the FC_ID with the text name of the fabric port to which the corresponding device is attached. Further details regarding one embodiment of how mapping of addresses according to the present invention can be accomplished are set forth below.

To obtain the mapping of FC_ID-to-fabric port, a probe can use, for example, Internet Protocol (IP) to communicate with a Simple Network Management Protocol (SNMP) agent in an fabric switch. To track changes to this mapping, a probe sets itself up to receive SNMP traps which indicate that a change in mapping may have occurred.

Version 2.2 of the Fibre Alliance (fcmgmt) Management Information Block (MIB) (the content of which is incorporated herein by reference in its entirety) should preferably be supported by the fabric switches of the present invention since version 2.2 is most widely supported by commercial devices. However, the same information is available in other versions of the MIB as well, and version 2.2 is being used merely for the sake of simplicity and the invention is not limited thereto.

A connUnit MIB table describes each switch in the fabric. For each switch in the fabric, the following MIB values are read:

Switch WWN—connUnitGloballd

Switch Name—connUnitName

Switch Model Name—connUnitProduct

Switch Info—connUnitInfo

A connUnitPort MIB table describes each port in the fabric. For eachfabric port in the fabric, the following MIB values are read:

Physical Port Number—connUnitPortPhysicalNumber

Port Name—connUnitPortName

Port Type—connUnitPortType

Port Speed—connUnitPortSpeed

Port Transmitter Type—connUnitPortTransmitterType

The physical port number is preferably included, because this parameter is used to associate the FC_ID of the attached device to the port name.

The port name is desirable, because all displayed references to the fabric port and any device connected to it will generally make use of it. If the port name is uninitialized, an alternative port name can be created from the switch name, port physical number, and the remaining descriptive switch and port parameters.

A connUnitLink MIB table describes connections between the fabric switch and remote devices. For each remote device connected to the switch, the following MIB values are read:

Fabric Port Physical Port Number—connUnitLinkPortNumberX

Port FC_ID—connUnitLinkConnIdY

The fabric port physical number is matched to a physical port number read from the connUnitPort table, to associate the FC_ID of the connected device with the information about the fabric port read from the port table.

In order to track dynamic changes to the fabric, the probe system of the present invention creates an entry in the trapReqTable (trap request table). The following values can be set, for example, for the entry:

trapReqIpAddress—IP address of the management system

trapReqPort—SNMP trap port for the management system

trapReqFilter—alert(3)

trapReqRowState—rowActive(3)

The following traps are acted upon:

connUnitStatusChange

connUnitPortStatusChange

Some fabric switches may also implement connUnitEventTraps reflecting configuration and/or topology events in the fabric. In such cases, these traps would be received as well.

If a connUnitStatusChange trap indicates a connUnitStatus of ok or a connUnitState of online, information in corresponding entries in connUnitTable, connUnitPortTable, and connUnitLinkTable are read from the switch agent's MIB again, and the probe system's state is preferably updated to reflect any changes.

If a connUnitPortStatusChange trap indicates a connUnitPortStatus of ok or a connUnitPortState of online, information in corresponding entries in connUnitPortTable and connUnitLinkTable are read from the switch agent's MIB again, and the probe system's state is updated to reflect any changes.

As access to storage grows exponentially, a probe system according to the present invention enables the administrator to manage availability and performance by:

Driving towards 100% uptime through proactive monitoring—knowing something will fail before it does,

Isolating problems instantaneously through real-time problem detection and reporting,

Monitoring I/O performance based on changing traffic types,

Planning infrastructure changes and growth through historical performance visibility, and

Knowing the impact of application and infrastructure changes proactively.

A probe system according to the present invention collects service-level performance data by directly monitoring the Fibre Channel port I/O. Fibre Channel ports that could significantly impact availability and performance of the SAN include:

E_Ports used for Inter-switch links (ISL) between edge switches and core directors or between core directors,

N_Ports on a RAID subsystem that are shared between one or more servers and applications,

E_Ports extended over the WAN using GigE or ATM transport for remote data access, disk mirroring, and data replication.

A probe system according to the present invention enables intelligent monitoring through user-definable threshold levels that ensure that those who need to know about critical events are notified in real time and when attention is required. A probe system according to the present invention provides service-level parameters at both the FC port and device (e.g., server, LUN) level. Performance visibility at the server level across a shared SAN port is an important aspect to the present invention as well as detailed port level monitoring. By having such information, an end user is able to properly plan, implement and managing SAN connectivity and performance. A probe system according to the present invention answers critical service-level question such as:

Who's contributing to the traffic (in MB/sec, SCSI IO/sec)?

What type of traffic (read/write percentages, transaction vs large file operations)?

When does the service degrade due to latency? Who contributes to this degradation?

Who's experiencing throughput problems (i.e., retransmissions)?

Who's experiencing availability (i.e., connectivity) problems (e.g., link resets)?

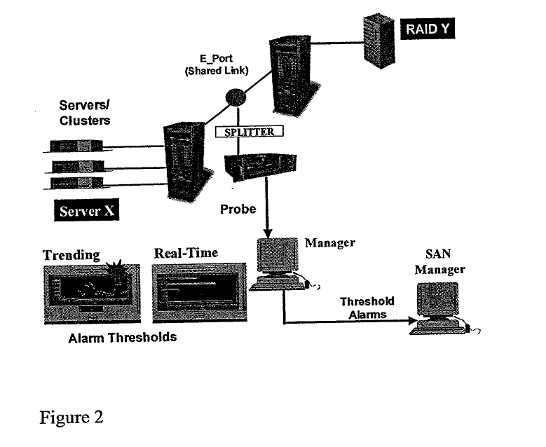

As shown in FIG. 2, it is possible to employ a dedicated probe that accesses the Fibre Channel port via an optical splitter (e.g., 90/10 splitter) and cannot be switched through software control. Alternatively, there can be provided a roaming probe that can be switched from port to port throughport mirroring, internal or external to the switch or director. The probe system according to the present invention is generally capable of mirroring any E_Port, N_Port, or GigE port for bidirectional monitoring.

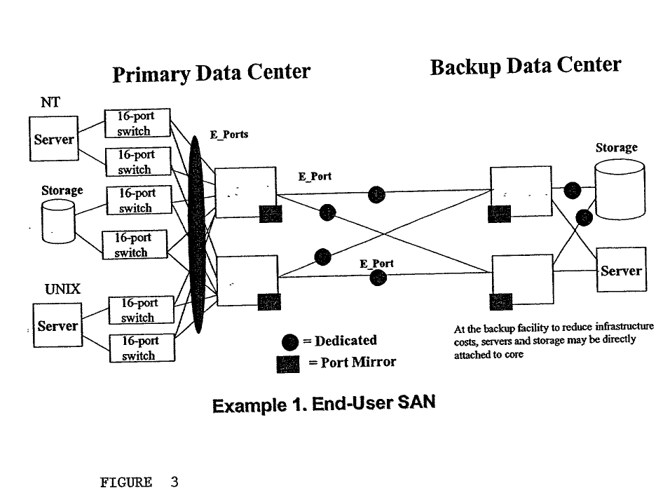

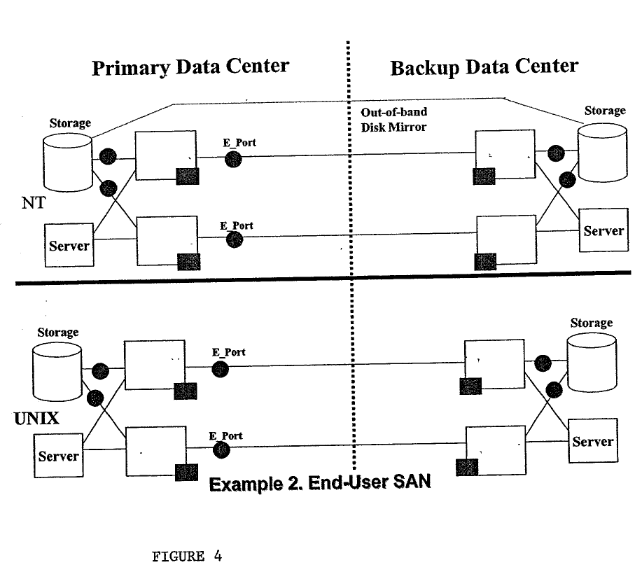

According to the proposed implementation of the present invention described in FIGS. 3 and 4, the SAN has no single point of failure within a Data Center. However, should the Primary Data Center experience multiple failures (e.g., redundant primary storage fails) or the entire Data Center goes off-line (e.g., disaster), then the Backup Data Center can assume partial or full operations through mirrored disks and/or redundant servers.

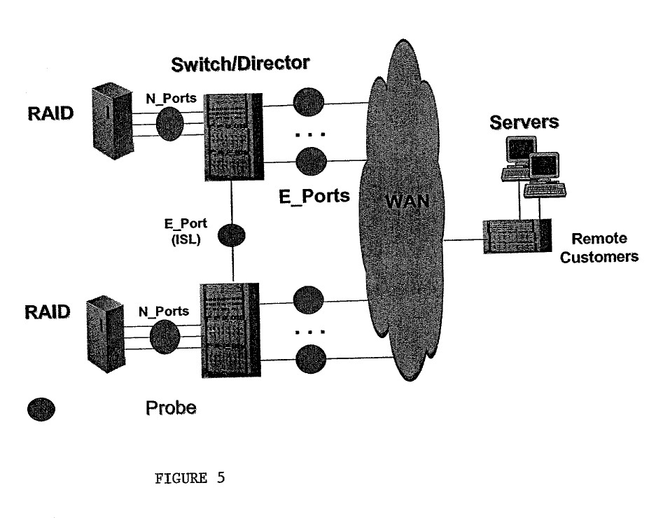

As shown, for example, in FIG. 5, service quality of the SAN in terms of utilization and availability at the port and device (e.g., Server) level for shared ISL ports is provided. Such an arrangement enables the SAN manager to plan and implement network moves/adds/changes and manage network service levels. Moreover, multiple ports are provisioned for a given RAID subsystem. A single N_Port to a RAID may transport data to/from multiple volumes accessed by multiple servers. To properly plan and implement network moves/adds/changes, the SAN manager needs to determine if a RAID port is oversubscribed or under-subscribed. If over-subscribed, he/she needs to know who is contributing to the load (e.g., which servers). Further, as shown in FIG. 5, WAN ports are capable of being monitored.

As used herein, the following terms are intended to have the meanings set forth below which are believed to be consistent with known Fibre Channel technology:

8B/10B The IBM patented encoding method used for encoding 8-bit data bytes to 10-bit Transmission Characters. Data bytes are converted to Transmission Characters to improve the physical signal such that the following benefits are achieved: bit synchronization is more easily achieved, design of receivers and transmitters is simplified, error detection is improved, and control characters (i.e., the Special Character) can be distinguished from data characters.

Arbitrated Loop One of the three Fibre Channel topologies. Up to 126 NL_Ports and 1 FL_Port are configured in a unidirectional loop. Ports arbitrate for access to the Loop based on their arbitrate loop physical address (AL_PA). Ports with lower AL_PA's have higher priority than those with higher AL_PA's.

BB_Credit Buffer-to-buffer credit value. Used for buffer-to-buffer flow control, this determines the number of frame buffers available in the port it is attached to, i.e., the maximum number of frames it may transmit without receiving an R_RDY.

Buffer-to-Buffer (flow control)—This type of flow control deals only with the link between an N_Port and an F_Port or between two N_Ports. Both ports on the link exchange values of how many frames it is willing to receive at a time from the other port. This value becomes the other port's BB_Credit value and remains constant as long as the ports are logged in. For example, when ports A and B log into each other, A may report that it is willing to handle 4 frames from B; B might report that it will accept 8 frames from A. Thus, B's BB_Credit is set to 4, and A's is set to 8.

Each port also keeps track of BB_Credit_CNT, which is initialized to 0. For each frame transmitted, BB_Credit_CNT is incremented by 1. The value is decremented by 1 for each R_RDY Primitive Signal received from the other port. Transmission of an R_RDY indicates the port has processed a frame, freed a receive buffer, and is ready for one more. If BB_Credit_CNT reaches BB_Credit, the port cannot transmit another frame until it receives an R_RDY.

B_Port A bridge port is a fabric inter-element port used to connect bridge devices with E-ports on a switch. The B_Port provides a subset of the E_port functionality.

Class n Fibre Channel Classes of service. Fibre channel (FC-2) defines several Classes of service. The major difference between the Classes of service is the flow control method used. The same pair of communicating ports may use different Classes of service depending on the function/application being served. Note that Class 1 service is not well defined/supported for FC over WAN configurations. All FC over WAN discussions in this document are for the transport of Class 2 or Class 3 traffic (and Class F traffic—see below).

Class 1 A method of communicating between N_Ports in which a dedicated connection is established between them. The ports are guaranteed the full bandwidth of the connection and frames from other N_Ports may be blocked while the connection exists. In-order delivery of frames is guaranteed. Uses end-to-end flow control only.

Class 2 A method of communicating between N_Ports in which no connection is established. Frames are acknowledged by the receiver. Frames are routed through the Fabric, and each frame may take a different route. In-order delivery of frames is not guaranteed. Uses both buffer-to-buffer flow and end-to-end flow control. Class 2 & 3 are used most often in the industry.

Class 3 Class 3 is very similar to Class 2. The only exception is that it only uses buffer-to-buffer flow control. It is referred to a datagram service. Class 3 would be used when order and timeliness is not so important, and when the ULP itself handles lost frames efficiently. Class 3 is the choice for SCSI. Class 2 & 3 are used most often in the industry.

Class 4 Class 4 provides fractional bandwidth allocation of the resources of a path through a Fabric that connects two N_Ports. Class 4 can be used only with the pure Fabric topology. One N_Port will set up a Virtual Circuit (VC) by sending a request to the Fabric indicating the remote N_Port as well as quality of service parameters. The resulting Class 4 circuit will consist of two unidirectional VCs between the two N_Ports. The VCs need not be the same speed.

Like a Class 1 dedicated connection, Class 4 circuits will guarantee that frames arrive in the order they were transmitted and will provide acknowledgement of delivered frames (Class 4 end-to-end credit). The main difference is that an N_Port may have more than one Class 4 circuit, possibly with more than one other N_Port at the same time. In a Class 1 connection, all resources are dedicated to the two N_Ports. In Class 4, the resources are divided up into potentially many circuits. The Fabric regulates traffic and manages buffer-to-buffer flow control for each VC separately using the FC_RDY Primitive Signal. Intermixing of Class 2 and 3 frames is mandatory for devices supporting Class 4.

Class 5 The idea for Class 5 involved isochronous, just-in-time service. However, it is still undefined, and possibly scrapped altogether. It is not mentioned in any of the FC-PH documents.

Class 6 Class 6 provides support for multicast service through a Fabric. Basically, a device wishing to transmit frames to more than one N_Port at a time sets up a Class 1 dedicated connection with the multicast server within the Fabric at the well-known address of hex‘FFFFF5’. The multicast server sets up individual dedicated connections between the original N_Port and all the destination N_Ports. The multicast server is responsible for replicating and forwarding the frame to all other N_Ports in the multicast group. N_Ports become members of a multicast group by registering with the Alias Server at the well-know address of hex‘FFFFF8’. The Class 6 is very similar to Class 1; Class 6 SOF delimiters are the same as used in Class 1. Also, end-to end flow control is used between the N_Ports and the multicast server.

Class F service As defined in FC-FG, a service which multiplexes frames at frame boundaries that is used for control and coordination of the internal behavior of the Fabric.

Class N service Refers to any class of service other than Class F.

Command Tag Queuing A SCSI-2 feature that is used when the initiator wants to 2 5 send multiple commands to the same SCSI address or LUN. Tagged queues allow the target to store up to 256 commands per initiator. Without tagged queues, targets could support only one command per LUN for each initiator on the bus. Per the SCSI-2 specification, tagged queue support by targets is optional.

Cut-through (routing) In a LAN switching environment the action of transmitting a frame on one port before all of that frame has been received from another port. Done for reasons of speed rather than integrity. Cf store and forward.

E_Port As defined in FC-SW-2, a Fabric expansion port which attaches to another E_Port to create an Inter-Switch Link.

Hard Zone A Zone which is enforced by the Fabric, often as a hardware function. The Fabric will forward frames amongst Zone Members within a Hard Zone. The Fabric prohibits frames from being forwarded to members not within a Hard Zone. Note that well-known addresses are implicitly included in every Zone.

Hub (FC) Hubs allow multiple FC ports (NL_Ports and at most one FL_Port) to interconnect in a FC-AL (arbitrated loop) topology. Hubs are often manageable, support the cascading of multiple Hubs to form larger FC-AL loops, and provide hot-plug for the FC-AL ports. Hubs may also provide full non-blocking performance on all ports by intelligently and dynamically allowing ports to arbitrate/communicate with each other independent of traffic on other loop ports (a hub/loop trick).

Initiator An initiator is a SCSI device that requests an I/O process be performed by another SCSI device (a target).

iSCSI A specification that covers the transport of SCSI

Fabric As defined in FC-FG (see reference [7]), an entity which interconnects various Nx_Ports attached to it and is capable of routing frames using only the D_ID information in an FC-frame header. In the FC-SW-2 standard, the term Fabric refers to switches that conform to the SW operational layer.

Fabric Element A Fabric Element is the smallest unit of a Fabric which meets the definition of a Fabric. A Fabric may consist of one or more Fabric Elements, interconnected E_Port to E_Port in a cascaded fashion, each with its own Fabric controller. To the attached N_Ports, a Fabric consisting of multiple Fabric Elements is indistinguishable from a Fabric consisting of a single Fabric Element.

F_Port a port in the fabric where an N_port or NL_port may attach

FC Fibre Channel (See FC-FS.)

FC-0 FC protocol layer defining physical characteristics (signaling, media, tx/rx specifications—See FC-PI)

FC-1 FC protocol layer defining 8B/10B character encoding and link maintenance (see FC-FS)

FC-2FC protocol layer defining frame formats, sequence/exchange management, flow control, classes of service, login/logout, topologies, and segmentation/re-assembly.

FC-3 Services for multiple ports on one node (See FC-FS).

FC-4 Upper Layer Protocol (ULP) mapping. FC-4 defines how ULPs are mapped over FC-FS. Popular ULPs include SCSI, FICON, IP, and VI.

FC-AL-2 NCITS Project 1133-D, Fibre Channel Arbitrated Loop—2

FC-BB NCITS Project 1238-D, Fibre Channel Backbone. The FC-BB specifications will provide the necessary mappings bridge between physically-separate instances of the same network definition, including MAC address mapping & translation, configuration discovery, management facilities and mappings of FC Service definitions. Currently the FC-BB specification covers only ATM and packet over SONET/SDH networks.

FC-BBW_ATM An ATM WAN interface specification that interfaces with Fibre Channel Switches on one side and ATM on the other.

FC-BBW_SONET/SDH A SONET/SDH WAN interface specification that interfaces with Fibre Channel Switches on one side and SONET/SDH on the other.

FC-FLA NCITS TR-20, Fibre Channel Fabric Loop Attachment

FC-FS NCITS Project 1311D, Fibre Channel Framing and Signaling Interface

FC-GS-3 NCITS Project 1356D, Fibre Channel Generic Services—3

FC-PH NCITS Project 755-M, Fibre Channel Physcial and Signaling Interface. FC-PH-3 was the last version of the FC-PH series of specs. Physical and signaling interfaces are now covered in FC-PI and FC-FS.

FC-PI NCITS Project 1306-D, Fibre Channel—Physical Interface.

FC-PLDA NCITS TR-19, Fibre Channel Private Loop, SCSI Direct Attach

FC-TAPE NCITS Project 1315D, Fibre Channel—Tape Technical Report

FC-VI NCITS Project 1332D, Fibre Channel—Virtual Interface Architecture Mapping. This goal of FC-VI is to provide a mapping between FC and VIA (Virtual Interface Architecture) “to enable scalable clustering solutions.”

FCP X3.269-1996, Fibre Channel Protocol for SCSI

FCP-2 Fibre Channel Protocol for SCSI, second version.

FC-4 Fibre Channel Layer 4 mapping layer. (See FC-FS.)

FL_Port a port in fabric where an N_Port or an NL_Port may attach

Fabric Login (FLOGI) Fabric Login Extended Link Service. (See FC-FS.). An FC-2defined process used by N/NL_Ports to

Frame The basic unit of communication between two N_Ports. Frames are composed of a starting delimiter (SOF), a header, the payload, the Cyclic Redundancy Check (CRC), and an ending delimiter (EOF). The SOF and EOF contain the Special Character and are used to indicate where the frame begins and ends. The 24-byte header contains information about the frame, including the S_ID, D_ID, routing information, the type of data contained in the payload, and sequence/exchange management information. The payload contains the actual data to be transmitted, and may be 0-2112 bytes in length. The CRC is a 4-byte field used for detecting bit errors in the received frame.

G_Port A generic Fabric_Port that can function either as an E_Port or an F_Port.

GL_Port A generic Fabric_Port that can function either as an E_Port or an FL_Port.

GBIC Gigabit Interface converter, these devices can be obtained in copper DB9, SSDC and Fibre Optic type connection. GBICS are hot swappable allowing reconfiguration to take place on a live system with no down time

HBA (host bus adapter)—this is the card that fits into the server workstation to provide the interface between the processor and Fibre Channel connection (loop, fabric)

Hunt Group A set of N_Ports with a common alias address identifier managed by a single node or common controlling entity. However, FC-FS does not presently specify how a Hunt Group can be realized.

Load Balancing A network feature that attempts to “balance” WAN traffic over more than one link in such a way as to maximize performance. Note that in some implementations load balancing only attempts to equalize throughput across multiple WAN links.

LUN (SCSI) Logical Unit Number. SCSI targets often support multiple LUNs (e.g. a device controller may manage multiple devices—each a separate LUN).

LUN Masking Method for limiting/granting access to specific LUNs from specific ports (for example, LUN Masking may be based on physical ports or World Wide Names). Similar in concept to zoning, but at a SCSI logical unit level.

LUN Zoning Same as LUN Masking.

N_Port a port attached to a node for use with point to point or fabric topology. Generally a port attached to a host or device. N_Ports communicate with other N_Ports and with F_Ports.

NL_Port a port attached to a node for use in all three FC topologies (loop, fabric, point-to-point). Generally a port attached to a host or device. NL_Ports communicate with other NL_Ports and with FL_Ports.

NA Not Applicable

Optical Carrier Level N (OC-N) The optical signal that results from an optical conversion of an STS-N signal. SDH does not make the distinction between a logical signal (e.g. STS-1 in SONET) and a physical signal (e.g. OC-1 in SONET). The equivalent SDH term for both logical and physical signals is synchronous transport module level M (STM-M), where M=(N/3). There are equivalent STM-M signals only for values of N=3,12,48, and 192.

OC-3 SONET 155.52 Mbps standard

OC-12 SONET 622.08 Mbps standard

OC-48 SONET 2.488 Gbps standard

PLOGI Port (N_Port) Login Extended Link Service (See FC-FS.)

Point Multi-Point A topology where one unit can communicate with multiple units.

Point-to-Point A topology where two points communicate

Port An access point in a device where a link attaches

Port (N_Port) Login (PLOGI) An FC-2defined login procedure used by N_Ports (e.g. hosts and devices) to register (identify) with each other and exchange parameters before communication may occur for ULPs.

Private Loop An Arbitrated Loop which stands on its own, i.e., it is not connected to a Fabric.

Private NL_Port An NL_Port which only communicates with other ports on the loop, not with the Fabric. Note that a Private NL_Port may exist on either a Private Loop or a Public Loop.

Public Loop An Arbitrated Loop which is connected to a Fabric.

Public NL_Port An NL_Port which may communicate with other ports on the Loop as well as through an FL_Port to other N_Ports connected to the Fabric.

PVC (Permanent Virtual Circuit) A pre configured logical connection between two ATM systems.

SAM-2 ITS Project 1157D, SCSI Architecture Model—2 (See 2.3.)

Sequence A group of related frames transmitted unidirectionally from one N_Port to another.

SCSI Small Computer System Interface, any revision.

SCSI-3 Small Computer System Interface-3, the SCSI architecture specified by SAM-2 and extended by the companion standards referenced in SAM-2.

SCSI-FCP Fibre Channel protocol for SCSI (refer to FCP, FCP-2 above)

SFC (Simple Flow Control) A mechanism wherein 2 bytes in the PAUSE field in the BBW_Header carries a non-zero value indicating the number of 512-bit time units to pause transmission (used in FC-BBW protocols)

SR Flow Control Selective Retransmission sliding window Flow Control Protocol applied between two BBW_ATM devices used for both flow control and error recovery (used in FC-BBW protocols)

Soft Zone A Zone consisting of Zone Members which are made visible to each other through Client Service requests. Typically, Soft Zones contain Zone Members that are visible to devices via Name Server exposure of Zone Members. The Fabric does not enforce a Soft Zone. Note that well known addresses are implicitly included in every Zone.

Svc Switched Virtual Circuit. A virtual link established through an ATM network. Used to establish the link end-points dynamically as the call is established. The link is removed at the end of the call.

Switch enabling devices for large fabrics. Can be connected together to allow scalability to thousands of nodes

Target A SCSI device that executes a command from an initiator to perform a task. Typically a SCSI peripheral device is the target but a host adapter may, in some cases, be a target.

T_Port A port on IRANGE/Qlogic switches that can be used to cascade/extend switches. T_Ports are not interoperable with other vendor's ports. Note that all INRANGE ports can act as any type (T/F/FL) of port.

ULP Upper layer protocol (See FC-FS.). Different communication protocols that can be carried by Fibre Channel.

WAN Wide Area Network. A network in which computers are connected to each other over a long distance, using telephone lines and satellite communications.

WDM Wavelength Division Multiplexing. A method for separating several communication channels within one fibre by using different colors of light to separate the channels

Zoning A logical separation of traffic between host and resources. By breaking up into zones, processing activity is distributed evenly. Zoning is primarily used for security (e.g. to prevent host access to certain devices).

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method for detecting an assignment change or an address change in an address identifier comprising:
identifying a user defined port address and a first address identifier associated therewith;
monitoring a topology change trap when a port becomes associated with an address identifier; and
triggering a command based on a detected topology change trap to map said address identifier to said user defined port name.

2. A method according to claim 1, wherein said address identifier is a fibre channel address identifier.

3. A method according to claim 2, wherein said address identifier comprises D_ID and/or S_ID.

4. A method for monitoring at least one port in a device by a monitoring system, said method comprising:
detecting an address identifier associated with said port;
associating said address identifier with a user-defined port name; and
monitoring topology change traps relating to said port, wherein, upon any change in assignment of said address identifier determined by a topology change trap, any subsequent address identifier is mapped to said user defined port name.

5. The method according to claim 4 further comprising recording said user-defined port name as a field in any data reported by the monitoring system.

6. A method according to claim 4, wherein said monitoring system comprises at least one probe.

7. A monitoring system capable of generating data that employs statistics or data referring to user-defined port names at least for purposes of archiving and/or viewing such data or statistics, said system comprising:
at least one probe, said probe comprising a mechanism for mapping an address identifier to a user defined port name such that upon a detected topology change trap by said system, any revised address identifier associated with any user defined port name is detected and stored by said monitoring system.

8. The system according to claim 7, wherein said probe is a software device.

9. The system according to claim 7, wherein said probe is a hardware device.

10. The system according to claim 7, wherein said user-defined port name is generated as at least one field for data collection.

11. The system according to claim 10, wherein said data is archived.

12. The system according to claim 10, wherein said data is used to generate reports.

13. A system for detecting an assignment change or an address change in an address identifier comprising:
means for identifying a user defined port address and a first address identifier associated therewith;
means for monitoring a topology change trap when a port becomes associated with an address identifier; and
means for triggering a command based on a detected topology change trap to map said address identifier to said user defined port name.

14. A system according to claim 13, wherein said address identifier is a fibre channel address identifier.

15. A system according to claim 13, wherein said address identifier comprises D_ID and/or S_ID.

16. A system for monitoring at least one port in a device by a monitoring system, said method comprising:
means for detecting an address identifier associated with said port;
means for associating said address identifier with a user-defined port name; and
means for monitoring topology change traps relating to said port, wherein, upon any change in assignment of said address identifier determined by a topology change trap, any subsequent address identifier is mapped to said user defined port name.

17. The system according to claim 16 further comprising means for recording said user-defined port name as a field in any data reported by the monitoring system.

18. A system according to claim 16, wherein said means for monitoring system comprises at least one probe.

19. The system according to claim 18, wherein said probe is a software device.

20. The system according to claim 18, wherein said probe is a hardware device.
